(19) United States
(12) Patent Application Publication
(10) Pub. No.: US 2025/0097919 A1
(43) Pub. Date: Mar. 20, 2025

(54) Radio Transmit Controller

(71) Applicant: Namero, LLC, Phoenix, AZ (US)

(72) Inventor: Matthew R. Jackson, Mesa, AZ (US)

(73) Assignee: Namero, LLC, Phoenix, AZ (US)

(21) Appl. No.: 18/825,279

(22) Filed: Sep. 5, 2024

Related U.S. Application Data
(60) Provisional application No. 63/538,999, filed on Sep. 18, 2023.

(51) Int. Cl. H04W 72/0453; H04L 5/00; H04W 28/20

(52) U.S. Cl. CPC H04W 72/0453; H04L 5/0048; H04L 5/0098; H04W 28/20

(57) ABSTRACT

Generally, a radio control system can provide the primary transmit controller or provide a secondary transmit controller to an existing radio transmit controller to control a radio control device. Specifically, a mobile application operable by a mobile device to provide a primary transmit controller, or provide a secondary transmit controller to an existing radio transmit controller, which receives and associates one or more channels of primary control instructions of a radio control device with one or more user interface elements of a radio control interface displayed on the mobile device which by user interaction generates secondary control instructions corresponding one or more channels of the primary control instructions to generate control signal data corresponding to the secondary control instructions to wirelessly control the radio control device.

This United States Non-Provisional Patent application claims the benefit of U.S. Provisional Patent Application No. 63/538,999, filed Sep. 18, 2023, hereby incorporated by reference herein.

### I. FIELD OF THE INVENTION

Generally, a radio control system can provide the primary radio controller or provide a secondary radio controller to an existing radio controller to control a radio control device. Specifically, a mobile application operable by a mobile device can provide a primary radio controller, or provide a secondary radio controller to an existing radio controller, which receives and associates one or more channels of primary control data of a radio control device with one or more user interface elements of a radio control interface displayed on the mobile device which by user interaction generates secondary control data corresponding one or more channels of the primary control data to generate servomechanism control outputs corresponding to the secondary control data to wirelessly control the radio control device.

### II. BRIEF DESCRIPTION OF THE DRAWINGS

FIG. 1 is a block diagram of the radio control system including hardware, software, and the interaction between components of the radio control system.

### III. DETAILED DESCRIPTION OF THE INVENTION

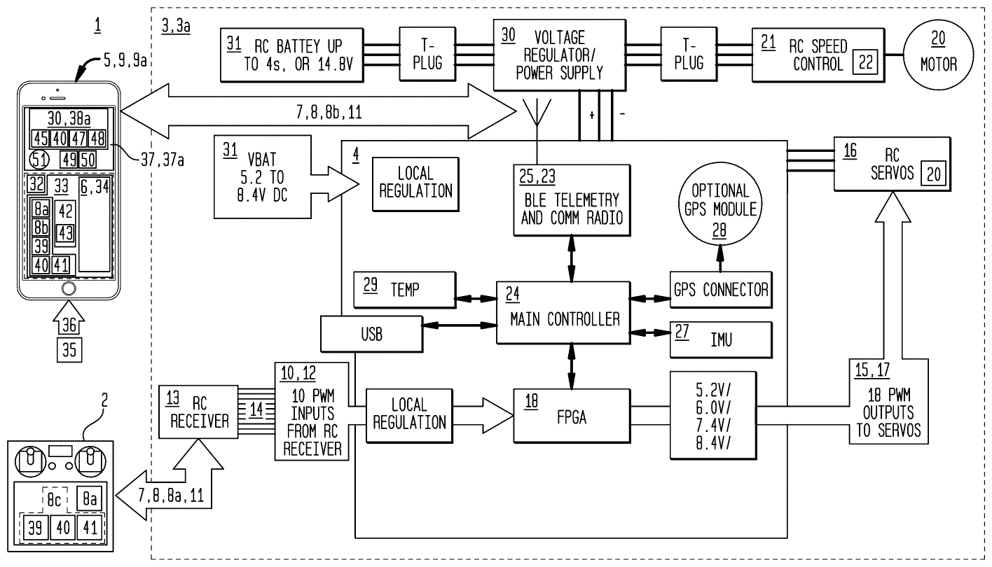

Now, with general reference to FIG. 1, embodiments of a radio control system (1) can include one or more of: a first radio controller (2), a radio control device (3) controllable by the first radio controller (2), a control box (4) disposed in the radio control device (3) which can be communicatively coupled to a second radio controller (5) operating a mobile application (6) compatible with iOS and/or Android operating systems, wherein the control box (4) can accept a radio control signal (7) from the first radio controller (2) and transmit the radio control signal (7) to the second radio controller (5), whereby the second radio controller (5) can optionally operate between the first radio controller (2) and the radio control device (3) to either override the radio control signal (7) to the radio control device (3) or regenerate the radio control signal (7) to the radio control device (3), and whereby the second radio controller (5) can operate as the primary radio control of the radio control device (3), or can operate as the secondary radio control of the radio control device (3).

For the purposes of this invention the term “radio control device (3)” means a machine or a component of a machine controlled from a distance by a radio controller (2 and/or 5) using a radio control signal (7) or electronic signals carrying radio control data (8) to control the operation of the machine or component of the machine, and without limitation to the breath of the foregoing a radio control device (3) can include, as illustrative examples: radio control vehicles, such as, cars, trucks, planes, trains, boats, helicopters; radio control robots; radio controlled animatronics; and drones.

For the purposes of this invention the term “first radio controller (2)” means a device that uses radio control signals (7) transmitted by radio to remotely control a radio control device (3).

For the purposes of this invention the term “second radio controller” means a mobile computing device (9) containing a mobile application (6) capable of, adapted to or configured to optionally receive a radio control signal (7) from a control box (4) in a remote control device (3), and optionally output radio control signal (7) to remotely control the radio control device (3) by either overriding the radio control signal (7) of the first radio controller (2) to the radio control device (3) or by regenerating the radio control signal (7) of the first radio controller (2) to the radio control device (3).

For the purposes of this invention “radio control signal(s) (7)” means radio waves including either analog signals or digital signals that by amplitude modulation, frequency modulation or in pulse width modulation (11), represent radio control data (8) to control the operation of components in a radio control device (3).

For the purposes of this invention “radio control receiver (13)” means a device adapted to receive radio control signal(s) (7) on a particular radio frequency band and decodes the radio control signal(s) (7) for each radio control channel (14) to correspondingly generate a servomechanism control inputs (10) to control one or more motor driven servomechanism (16). In particular embodiments, the radio control receiver (13) can generate servomechanism control inputs (10) as pulse width modulated inputs (12). In particular embodiments, the radio receiver can generate pulse with modulated inputs (17) which can be further processed by a field programmable gate Array (FPGA) (18) to provide servomechanism control outputs (15) to each motor driven servomechanism (16). As an illustrative example, the radio control receiver (13) can generate ten pulse width modulated inputs to the FPGA (18) and the FPGA can further process the pulse width modulated inputs to generate 18 pulse width modulated outputs (17) to control one or more motor driven servomechanism (16).

For the purposes of this invention “radio control channel (19)” means a radio frequency within a radio frequency band dedicated to radio control signal (7) to control one motor driven servomechanism (16). In particular embodiments, there can be as many as 18 radio control channels each dedicated to a servomechanism control output (15) to a corresponding one motor driven servomechanism (16).

For the purposes of this invention “pulse width modulation (11)” means conversion of an analog signal by a microprocessor into rectangular waveforms where the width of the waveform varies in proportion to the amplitude of the analog signal. The pulse width modulated output (17) can be communicatively coupled to motor driven servomechanism (16) with a feedback sensor for position control. The duty cycle of the pulse width modulation output (17) can be varied to control of the operation of a motor (20) of a motor driven servomechanism (16), and in certain instances, mathematical relationships between the duty cycle and the amount of torque generated by the motor (20) can be established in a lookup table.

For the purposes of this invention the term “radio control speed control (21)” means a speed control processing unit (22) that receives pulse width modulated outputs (17) from the FPGA (18) to control the speed and direction of a motor (20) within a radio control device (3) based on radio control signals (7) from the first radio controller (2) or the second radio controller (5).

For the purposes of this invention the term “control box (4)” means a device capable of, adapted to, or configured to receive radio control signal(s) (7) from a first radio controller (2) and communicate the radio control signal(s) (7) to a second radio controller (5) and further operates to receive radio control signal(s) (7) from the second radio controller (5) to control the radio control device (3), without limitation to the breadth of the foregoing communication between the control box (4) and the second radio controller (5) can be by Bluetooth® (23).

For the purposes of this invention the term “Bluetooth® (23)” means with a short-range wireless technology standard that is used for exchanging data between fixed and mobile devices over short distances using a frequency of 2.45 GHZ with transmission power typically limited to 2.5 milliwatts.

Now with primary reference to FIG. 1, particular embodiments of the control box (4) can include a main controller (24). A main controller (24) suitable for use in embodiments of the invention can be an Advance RISC Machine (ARM) based microcontroller. The main controller (24) can communicate with associated hardware or peripheral digital integrated circuits via an inter-integrated circuit (I2C), serial peripheral interface (SPI) and/or universal asynchronous receiver (UART) interfaces.

The main controller (24) can be communicatively coupled to the field programmable gate array (FPGA) (18) which can be programmed to generate and monitor pulse width modulated output (17) for variable duty cycles to servomechanisms (16). In particular embodiments, the FPGA (18) can be programed to generate pulse width modulated outputs (17) using very high-speed integrated circuit hardware description language (VHDL).

Again, with primary reference to FIG. 1, the main controller (24) can be communicatively coupled to a Bluetooth® telemetry and radio communications device (25) to provide Bluetooth® wireless radio communication, including, but not limited to, telemetry data (26) to the second radio controller (5). A suitable Bluetooth® telemetry and radio communications device (25) for use in particular embodiments can be an ESP32 Wi-Fi and Bluetooth® microcontroller including in-built antenna switches, RF balun, power amplifier, low-noise receive amplifier, filters, and power management modules.

Again, with primary reference to FIG. 1, the main controller (24) can be further communicatively coupled to an inertial measurement unit (IMU) (27). The IMU (27) provides the current movement status of the radio control vehicle (3) to the second radio controller (5). The IMU (27) can comprise a single on-board three-axis accelerometer with gyroscope to output of one or more signals associated with yaw, pitch and roll rate and longitudinal, lateral and vertical acceleration. IMU (27) can communicate with the main controller (25) via a serial peripheral interface.

Again, with primary reference to FIG. 1, the main controller (25) can be further communicatively coupled to an external global positioning module (GPS) (28). In particular embodiments, the GPS module (28) can comprise a universal asynchronous receiver/transmitter (UART) serial communication protocol to effectively communicate between the GPS module (28) and the main controller (25)

Again, with primary reference to FIG. 1, the main controller (25) can be further communicatively coupled to a negative temperature coefficient thermistor (NTC thermistor) (29) for printed circuit board temperature monitoring.

Again, with primary reference to FIG. 1, in particular embodiments, the control box (4) can further comprise a voltage regulator (VREG) (30) to receive raw voltage and generate an output voltage to power components of the control box (4). Input voltage can occur within a range of 5.5 VDC and 17 VDC. In particular embodiments the radio control device (3) can include one or more batteries (31). The battery (31), as one example, can be a 14.8 V lithium-polymer battery having 4S form factor of 4 cells in series, although this is not intended to preclude other form factors such as 3S, 2S or combinations thereof. The output voltage can always generate a lower output voltage than the input voltage since buck power switching technology can be employed to step down the voltage from the input supply to the output load. The output voltage can be selectable from 3.0 V to 15 V with the output always at least about 1 V lower than the input voltage with 10A average maximum current output and 20A transient maximum current output. In particular embodiments, the output voltage can be as examples 5.2 V, 6.0 V, 7.4 V, and/or 8.4 V depending on the motor driven servomechanism. The VREG (30) and can be connected to the main controller (25) by a 4-pin harness to supply an I2C connection to set the output voltage of the VREG (30). Battery voltage can be reported to the main controller (25) from a direct wire connection to the battery (31) to allow direct battery measurement.

Again, with primary reference to FIG. 1, the second radio controller (5) includes a processor (32) communicatively coupled to a non-transitory computer readable media (33) (also referred to as a “memory element”) containing the mobile application (6) compatible with iOS and Android operating systems. For the purpose of this invention, the term “mobile application (6)” means a software application adapted to run on a mobile computing device (9). The second radio controller (5), while shown in FIG. 1 as a mobile computing device (9) in the form factor of a cellular phone (9a), can be any form of mobile computing device such as personal computers, slate computers, tablet or pad computers, cellular telephones, personal digital assistants, smartphones, programmable consumer electronics, or the like. The mobile application (6) includes a program code (34) to afford control over Bluetooth® to one or a plurality of radio control devices (3).

In the illustrative example of a radio control vehicle (3a), the mobile application (6) can function to allow a user (35) of the second radio controller (5) to wirelessly receive the primary radio control data (8a) being transmitted by the first radio controller (2). The primary radio control data (8a) can correspond to one or more radio control channels (14) associated with a user command (36) of the radio control vehicle (3). The primary radio control data (8a) corresponding to one or more radio control channels (14) can be recorded in the memory element (33) of the second radio controller (5). The program code (34) can further operate to associate or map the primary radio control data (8a) with or to a corresponding one or more user interface elements (38) of a radio control user interface (37) of the second radio controller (5). Secondary radio control data (8b) can then be generated based on one or more user commands (36) by user (35) interaction with one or more user interface elements (38) of the radio control user interface (37). The secondary radio control data (8b) based on a user command (36) can be transmitted to the control box (4) through the Bluetooth® communications device (25). In this way, the control box (4) is compatible with any existing radio control receiver (13). The radio control vehicle (3) can then be wirelessly controlled with the secondary control data (8b) corresponding to user commands (36) in the radio control user interface (37) of the second radio controller (5), whereby the second radio controller (5) can optionally operate between the first radio controller (2) and the radio control vehicle (3) to either override the primary radio control data (8a) to the radio control device (3), or to regenerate the primary radio control data (8a) to the radio control device (3), or the second radio controller (5) can operate as the primary radio control of the radio control vehicle (3) or can operate as the secondary radio control of the radio control vehicle (3).

In more detail, the mobile application (6) including the program code (34) contained in the memory element (33) of the second radio controller (5) can be executed to allow the mobile computing device (9) to pair with the radio control vehicle (3) and to allow user commands (36) to be entered into the radio control user interface (37) to generate secondary vehicle control data (8b) that can enable or disable the input or output of pulse width modulation (11) of one or more radio control channels (14) of primary radio control data (8a). In particular embodiments, the secondary vehicle control data (8b) can be generated to trim or adjust the primary vehicle control data values (8c) of one or more radio control channels (14) without necessarily altering the primary vehicle control data values (8c) stored in the first radio controller (2). The second radio controller (5) can then generate secondary control data (8b) to operate the radio control vehicle (3) within the trimmed or adjusted primary vehicle control data values (8c). As an illustrative example, the secondary vehicle control data (8b) can be generated to trim or adjust the length of a pulse width modulated duty cycle of the primary vehicle control data (8a) without necessarily altering the duty cycle stored in the first radio controller (2). In further detail as illustrative examples, the secondary vehicle control data (8b) can trim a top value setting (39) and/or a bottom value setting (40) of one or more radio control channels (14). Similarly, the secondary vehicle control data (8b) can be generated to trim a center point value (41) associated with one or more radio control channels (14). In operation, the secondary vehicle control data (8b) can be generated to toggle between the trim top value (39) and trim bottom value (40) controlled by one or more radio control channels (14) to corresponding drive one or more servomechanisms (16) between the trim top value (39) and said trim bottom value (40) or to the trim center point value (41).

In particular embodiments, the program code (34) can be executed to record primary vehicle control data (8a) of one or more radio control channels (14) associated with one more user commands (36) as a pattern control command (42) saved in the memory element (33) of the second radio controller (5). The pattern control command (42) can be executed by user interaction in the radio control user interface (37) to generate the secondary vehicle control data (8b) in one or more radio control channels (14) to wirelessly control movement of the radio control vehicle (3) corresponding to the pattern control command (42). As an example, by user interaction in the radio control user interface (37), a plurality of or one or more series of primary vehicle control data (8a) can be grouped together and recorded as a macro code (43) defining a pattern control command (42) corresponding to a remote control vehicle action, or series of actions, which can be initiated by a single user input in the radio control user interface (37). The macro code (43) upon initiation by a user interaction in the radio control interface (37) of the second radio controller (5) can cause the remote control vehicle (3) to perform complex movements which would otherwise be difficult or impossible to execute, such as, radio control vehicle hopping or dance moves which may be timed to music.

Again, referring to FIG. 1, in particular embodiments the radio control user interface (37) can comprise a graphical user interface (37a) configured to receive user commands (36) that individually or concurrently control pulse width modulated outputs (17) in one or more radio control channels (14). The graphical user interface elements (38a) displayed on the display surface (44) of a mobile computing device (9) allow user interaction to enable or disable one or more of the radio control channels (14), set top and bottom trims values (39, 40) for each radio control channel (14), set the level of pulse width modulated outputs (17) to control servomechanism position (which may be by a slider interface element), set center point value (41), and afford channel reversing to correct servomechanism (16) direction. In particular embodiments, the graphical user interface (37a) can include graphical user interface elements (38a) corresponding to one or more of: a button mode (45) to momentary drive a servomechanism (16) between a top value (39) and a bottom value (40) with trim, a position button mode (46) to drive servomechanism between a top value and a bottom value with trim and center point, a toggle mode (47) to drive servomechanisms (16) between to options, a joystick mode (48) to provide two channel control with liner drive between top values (39) and bottom values (40) with snap back to center point value (41) upon release.

Again, with primary reference to FIG. 1, particular embodiments of the graphical user interface (37a) can include one or more graphical telemetry elements (49) configured to display telemetry values (50). The telemetry values (50) can include as illustrative examples: circuit board temperature, battery voltage, radio signal strength, channel output values, vehicle orientation (pitch, roll yaw angle). In particular embodiments, GPS values (51) can be displayed.

As can be easily understood from the foregoing, the basic concepts of the present invention may be embodied in a variety of ways. The invention involves numerous and varied embodiments of a radio transmit controller system and methods for making and using such radio transmit controller system including the best mode.

As such, the particular embodiments or elements of the invention disclosed by the description or shown in the figures or tables accompanying this application are not intended to be limiting, but rather illustrative of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “signal” should be understood to encompass disclosure of the act of “signaling”—whether explicitly discussed or not—and, conversely, were there effectively disclosure of the act of “signaling”, such a disclosure should be understood to encompass disclosure of a “signal” and even a “means for signaling.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in Merriam-Webster's Collegiate Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) the radio control system and each of the radio controllers herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A radio control system to control a radio control vehicle, comprising:
a mobile device including a processor communicatively coupled to a non-transitory computer readable medium containing a program code executable to:
wirelessly receive primary radio control data corresponding to one or more channels associated with a control command of said radio control vehicle;
associate each of said one more channels of said primary radio control data with a corresponding one or more user interface elements of a radio control vehicle user interface on said mobile device;
generate, by user indications in said radio control vehicle user interface, secondary radio control data corresponding to said one or more channels of said primary radio control data;
transmit said secondary control signal data to said radio control vehicle; and
wirelessly control said radio control vehicle with said secondary radio control data.

2. The system of claim 1, wherein said secondary radio control data enables or disables input of pulse width modulation of said one or more channels of said primary radio control data.

3. The system of claim 2, wherein said secondary radio control data enables or disables output of pulse width modulation of said one or more channels of said primary vehicle control data.

4. The system of claim 3, wherein said secondary radio control data alters the primary radio control data of one or more channels to correspondingly trim a top value and/or a bottom value controlled by said one or more channels.

5. The system of claim 4, wherein said secondary radio control data alters the primary radio control data of one or more channels to correspondingly trim center point associated with said one or more channels.

6. The system of claim 5, wherein said secondary radio control data toggles between a trim top value and a trim bottom value controlled by said one or more channels to drive a servomechanism between said trim top value and said trim bottom value.

7. The system of claim 6, wherein said secondary vehicle control data toggles between said trim top value and said trim bottom value controlled by said one or more channels to drive a servomechanism between said trim top value and said trim bottom value with corresponding trim center point.

8. The system of claim 7, wherein said program code executable to record a series of primary radio control data as pattern control command wherein said secondary radio control data includes said pattern control command in said secondary control data to wirelessly control said radio control vehicle.

9. A method of making a radio control system to control a radio control vehicle, comprising:
communicatively coupling a processor to a non-transitory computer readable medium containing a program code in a mobile device, said program code executable to:
wirelessly receive primary radio control data corresponding to one or more channels associated with a control command of said radio control vehicle;
associate each of said one more channels of said primary radio control data with a corresponding one or more user interface elements of a radio control vehicle user interface on said mobile device;
generate secondary control data based on selected user interface elements of said radio control interface;
transmit said secondary control data to said radio control vehicle; and
wirelessly control said radio control vehicle with said secondary control signal data based on said secondary vehicle control instructions.

10. (canceled)

11. A radio control system, comprising:
a mobile device including a processor communicatively coupled to a non-transitory computer readable medium containing a program code executable to:
wirelessly receive primary radio control data corresponding to one or more channels associated with a control command of a radio control device;
associate each of said one more channels of said primary radio control data with a corresponding one or more user interface elements of a radio control user interface on said mobile device;
generate secondary radio control data based on selected user interface elements of said radio control interface;
transmit secondary radio control data to said radio control device; and
wirelessly control said radio control device based on said secondary radio control data.

12. The radio control system of claim 11, wherein said device comprises a radio control vehicle.

13. The radio control system of claim 11, wherein said device comprises pulse width modulated components.

14. The radio control system 13, wherein said width modulated components comprise one or more servomechanisms.
